(19) United States
(12) Patent Application Publication
(10) Pub. No.: US 2018/0318994 A1
(43) Pub. Date: Nov. 8, 2018

(54) ELECTRIC STAPLER

(71) Applicant: APEX MFG. CO., LTD., Taichung City (TW)

(72) Inventors: Chih-Wei HU, Taichung City (TW); Py-Yi CHANG, Taichung City (TW)

(21) Appl. No.: 15/588,104

(22) Filed: May 5, 2017

(51) Int. Cl. B25C 5/02; B25C 5/15

(52) U.S. Cl. CPC B25C 5/0228; B25C 5/15

(57) ABSTRACT

The elastic stapler includes a main body, a striking device, a switch structure, and an elastic guiding element. The main body has a front opening and a working platform below the front opening. The striking device is arranged in the receiving space and has a movable striking mechanism. The switch structure is connected to the striking device. When a papersheet is inserted into the front opening of the main body to trigger the switch structure, the striking mechanism moves downward to strike a nail out. The elastic guiding element is arranged at the front opening of the main body. When the striking mechanism moves downward, the elastic guiding element abuts against the papersheet, and the elastic guiding element is compressed to bring the papersheet inward.

### BACKGROUND OF THE INVENTION

### Field of the Invention

The present invention relates to an electric stapler.

### Description of the Prior Art

A conventional electric stapler is shown in patent TW 577378. A button or triggering piece is arranged inside the opening of the stapler. When a papersheet is inserted into the opening, the papersheet pushes the button to trigger a switch. Thus, a striking device of the stapler strikes a nail out.

However, the user must take the papersheets by hand to position the papersheets visually. Thus, the position of the nail is not precise, especially when the number of the papersheets is small.

### SUMMARY OF THE INVENTION

The main object of the present invention is to provide an electric stapler to bring papersheets inward to make the position of nail precise.

To achieve the above and other objects, an electric stapler of the present invention includes a main body, a striking device, a switch structure, and an elastic guiding mechanism.

The main body encloses a receiving space and has a front opening. The main body has a working platform at a bottom of the front opening. The striking device is arranged in the receiving space and includes a striking mechanism. The striking mechanism is movable between an original position and a striking position. The striking mechanism tends to retain at the original position. The striking mechanism has a striking portion. The switch structure is connected to the striking device. The switch structure triggers the striking mechanism to move to the striking position to drive the striking portion to strike a nail out when the switch structure is triggered. The elastic guiding element is located at the front opening of the main body. The elastic guiding element includes a guiding portion, an elastic means, and a pivot portion. The pivot portion is pivotally disposed on a front portion of the striking mechanism. The guiding portion extends toward the striking portion and is pivotable up and down. The guiding portion tends to pivot downward due to the elastic means. When the striking mechanism moves to the striking position, the guiding portion abuts against a papersheet placed on the working platform so that the guiding portion pivots upward to compress the elastic means and that the guiding portion further pulls the papersheet toward the striking portion.

Thereby, the electric stapler can ensure the position of the nail precise and correct.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is s stereogram of the present invention;

FIG. 2 is a breakdown drawing of the present invention;

FIG. 3 is a profile of the present invention;

FIGS. 4 to 6 are illustrations of the present invention when triggering;

FIG. 7 is a stereogram of a pivot element of the present invention;

FIG. 8 is a stereogram of an elastic guiding element of the present invention;

FIG. 9 is an illustration of the present invention;

FIGS. 10 and 11 are illustrations of the present invention when guiding;

FIG. 12 is a partial breakdown drawing of the present invention.

### DETAILED DESCRIPTION OF THE PREFERRED EMBODIMENTS

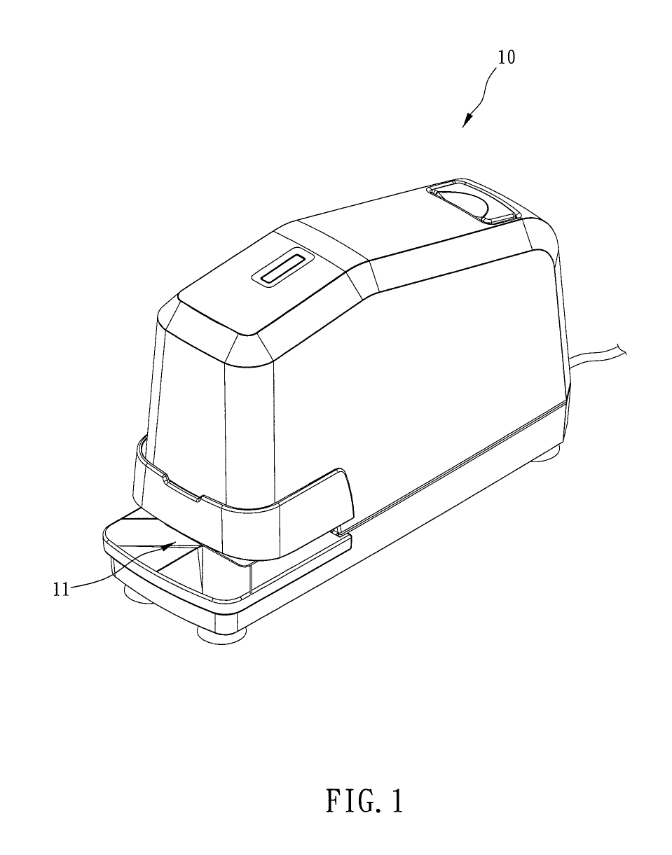

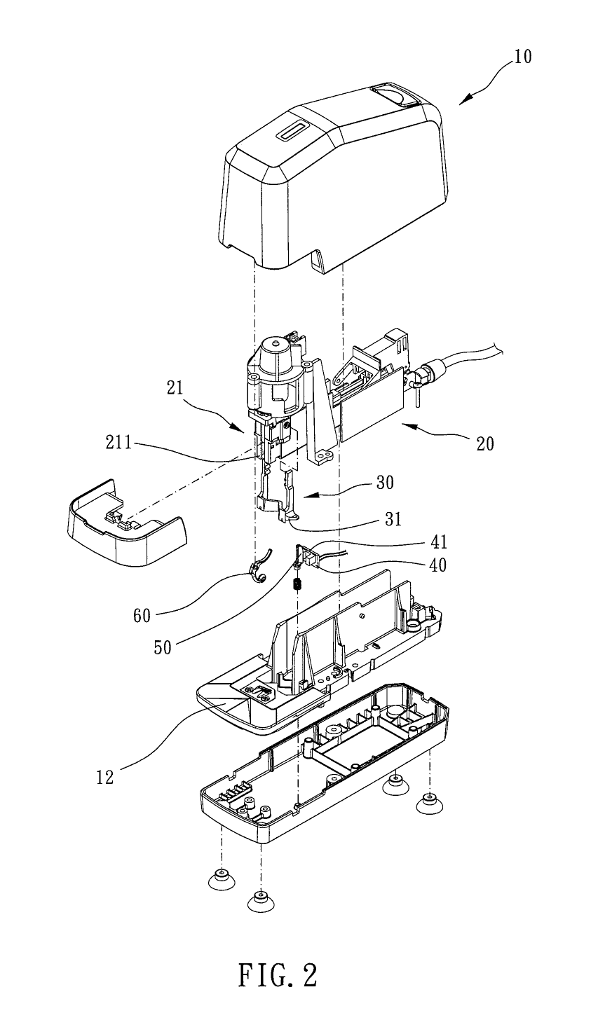

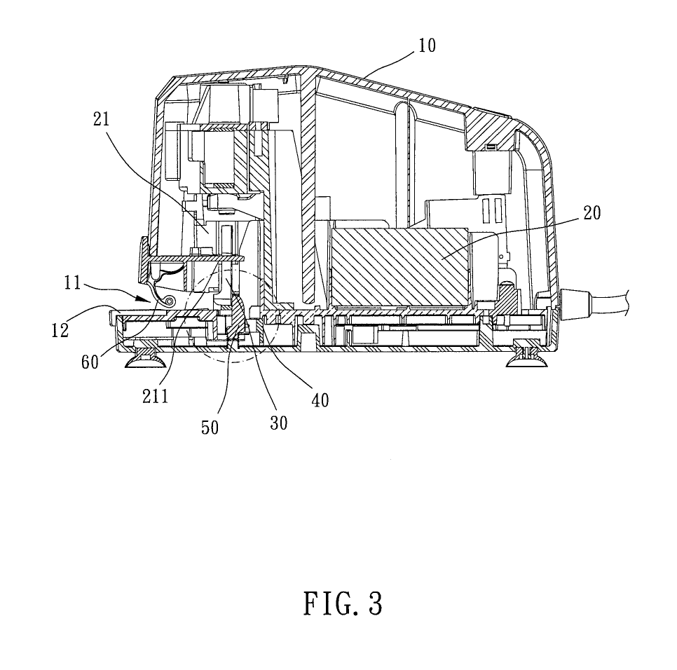

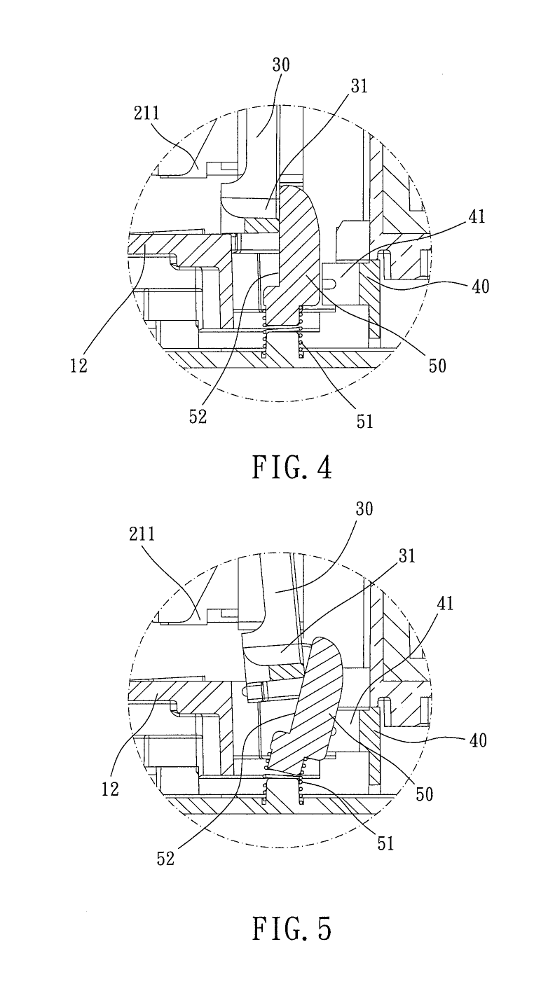

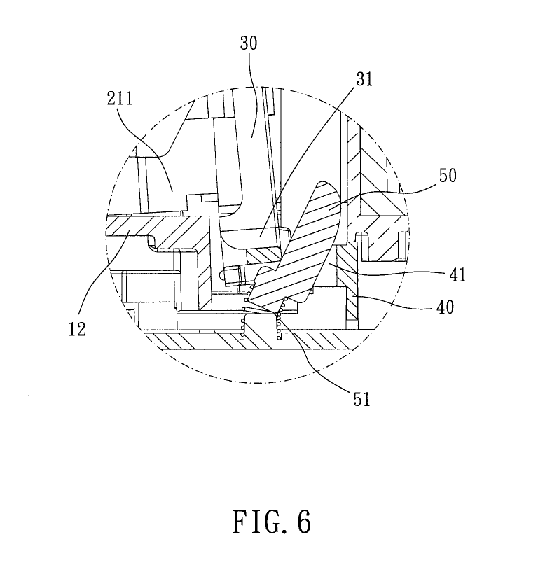

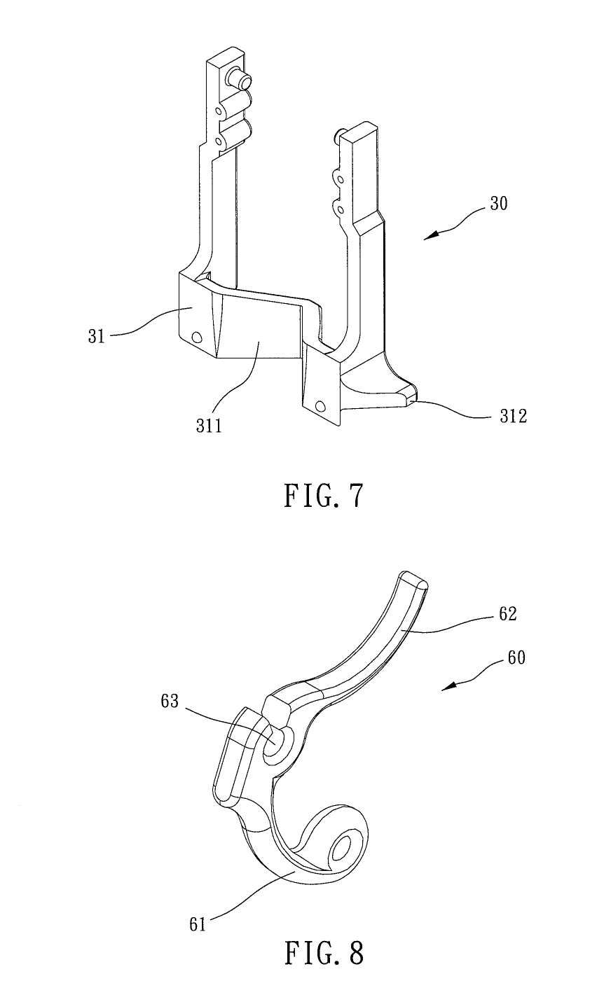

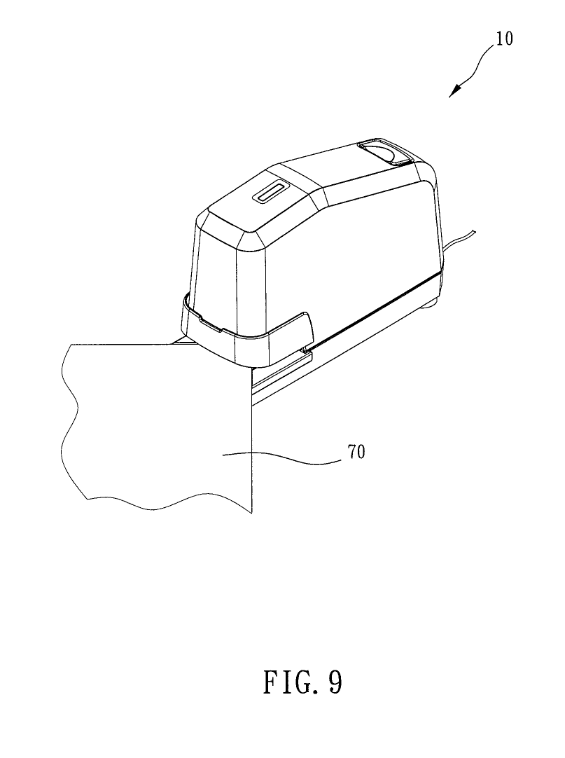

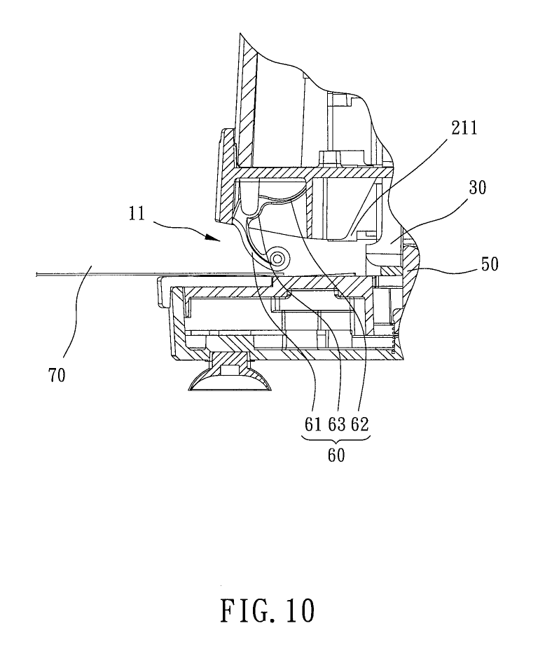

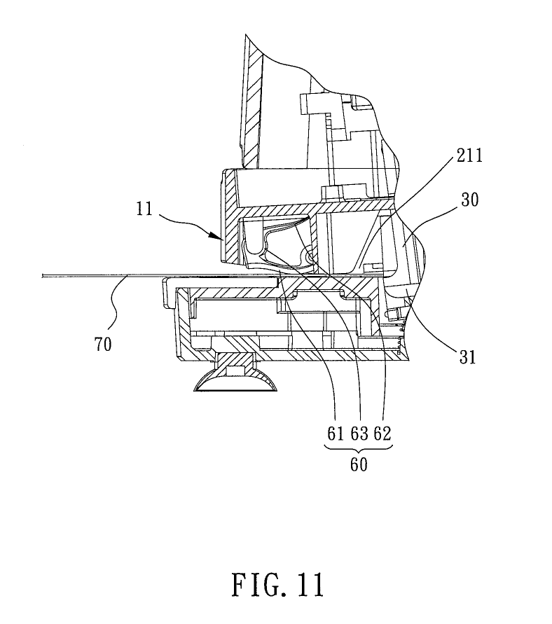

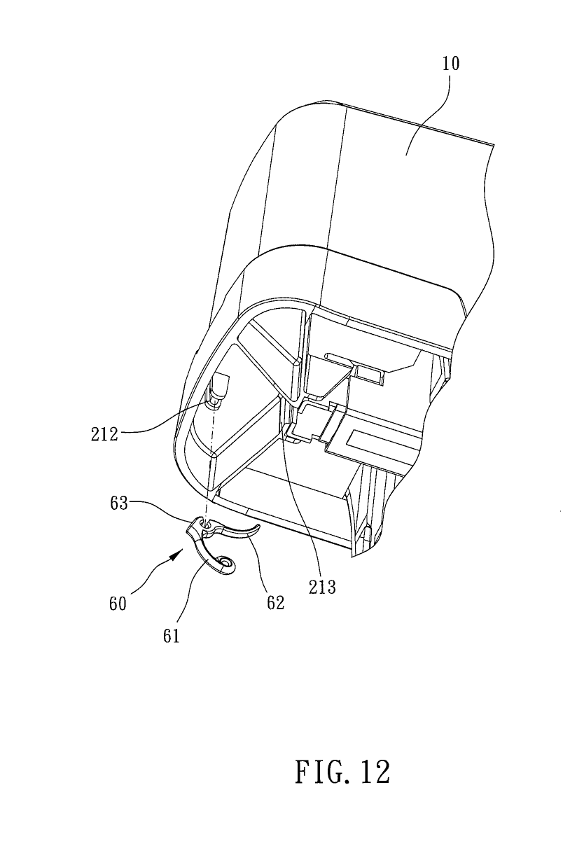

Please refer to FIG. 1 to FIG. 12, the electric stapler of the present invention includes a main body 10, a striking device 20, a switch structure, and an elastic guiding element 60.

The main body 10 encloses a receiving space and has a front opening 11. The main body 10 has a working platform 12 at a bottom of the front opening 11. The striking device 20 is arranged in the receiving space and includes a striking mechanism 21. The striking mechanism 21 is movable between an original position and a striking position. The striking mechanism 21 tends to retain at the original position. The striking mechanism 21 has a striking portion 211. The switch structure is connected to the striking device 20. The switch structure triggers the striking mechanism 21 to move to the striking position to drive the striking portion 211 to strike a nail out when the switch structure is triggered. The elastic guiding element 60 is located at the front opening 11 of the main body 10. The elastic guiding element 60 includes a guiding portion 61, an elastic means 62, and a pivot portion 63. The pivot portion 61 is pivotally disposed on a front portion of the striking mechanism 21. The guiding portion 61 extends toward the striking portion 211 and is pivotable up and down. The guiding portion 61 tends to pivot downward due to the elastic means 62. When the striking mechanism 21 moves to the striking position, the guiding portion 61 abuts against a papersheet 70 placed on the working platform 12 so that the guiding portion 61 pivots upward to compress the elastic means 62 and that the guiding portion 61 further pulls the papersheet 70 toward the striking portion 211.

In the present embodiment, the elastic guiding element 60 is formed as a single piece by a resilient material. The pivot portion 63 is located between the guiding portion 61 and the elastic means 62. The elastic means 62 is arranged above the guiding portion 61 and is arc-shaped normally. When the guiding portion 61 is pressed upward, the pivot portion 63 pivots with respect to the striking mechanism 21 so that the elastic means 62 is compressed by the pivot portion 63 to be flatter. Preferably, the guiding portion 61 is also arc-shaped. A curvature center of the guiding portion 61 is located above the guiding portion 61 and between the pivot portion 63 and the striking portion 211. A curvature center of the elastic means 62 is located above the elastic means 62. Besides, the striking mechanism 21 has a pivot axle 212 and an abutting face 213. The pivot portion 61 of the elastic guiding element 60 is pivotally connected to the pivot axle 212. An end of the elastic means 62 remote from the pivot portion 63 abuts against the abutting face 213. Preferably, the striking mechanism 21 further includes a front cover. The pivot axle 212 and the abutting face 213 are located at a face of the front cover facing the working platform 12.

On the other hand, the switch structure includes a pivot element 30, a switch 40, and a triggering element 50. An end of the pivot element 30 is pivotally connected to the striking mechanism 21, and an other end of the pivot element 30 has a pressing portion 31. The pivot element 30 is closer to the front opening 11 of the main body 10 than the striking portion 211 is. The switch 40 is arranged in the receiving space and is connected to the striking device 20. The switch 40 triggers the striking mechanism 21 to move to the striking position to drive the striking portion 211 to strike a nail out when the switch 40 is triggered. The triggering element 50 is movably arranged between the switch 40 and the pressing portion 31 of the pivot element 30. The triggering element 50 is movable between a reset position and a triggering position. The triggering element 50 tends to retain at the reset position. When the pressing portion 31 of the pivot element 30 is pushed by a papersheet 70, the triggering element 50 is pushed to move toward the triggering position. When the triggering element 50 is located at the triggering position, the triggering element 50 triggers the switch 40. More specifically, the pressing portion 31 of the pivot element 30 includes a pressing face 311 and a pushing portion 312. The pressing face 311 is V-shaped for a corner of the papersheet 70 to abut against. The pushing portion 312 is adapted for pushing the triggering element 50. Besides, the triggering element 50 includes an elastic element 51. The triggering element 50 is positioned on a bottom of the main body 10 via the elastic element 51 and tends to retain at the reset position. In addition, the triggering element 50 is formed with a recess 52 on a face thereof facing the pivot element 30. The recess 52 extends along a vertical direction to allow the pivot element 30 to move up and down.

The switch 40 can be a U-shaped photoelectric switch and has a sensing groove 41. A ray is emitted from a lateral wall of the sensing groove 41 and is detected by another lateral wall of the sensing groove 41. When the triggering element 50 is located at the triggering position, the triggering element 50 is at least partially received in the sensing groove 41 to block the ray. When the switch 40 doesn't detect the ray, the striking device 20 is driven to strike the nail out.

In use, the papersheet 70 is inserted into the front opening 11 of the main body 10 with a corner thereof to abut against the pressing face 311 the pivot element 30, and the papersheet 70 further pushes the pivot element 20 to further push the triggering element 50 to trigger the switch 40. Thereby, the striking mechanism 21 is driven to move down to strike the nail out. Besides, the elastic guiding element 60 can position the papersheets and further pull the papersheets inward to make the papersheets orderly and to make the position of the nail precise.

What is claimed is:

1. An electric stapler, including:
a main body, enclosing a receiving space and having a front opening, the main body having a working platform at a bottom of the front opening;
a striking device, arranged in the receiving space and including a striking mechanism, the striking mechanism being movable between an original position and a striking position, the striking mechanism tending to retain at the original position, the striking mechanism having a striking portion;
a switch structure, connected to the striking device, the switch structure triggering the striking mechanism to move to the striking position to drive the striking portion to strike a nail out when the switch structure is triggered;
an elastic guiding element, located at the front opening of the main body, the elastic guiding element including a guiding portion, an elastic means, and a pivot portion, the pivot portion being pivotally disposed on a front portion of the striking mechanism, the guiding portion extending toward the striking portion and being pivotable up and down, the guiding portion tending to pivot downward due to the elastic means, when the striking mechanism moves to the striking position, the guiding portion abutting against a papersheet placed on the working platform so that the guiding portion pivots upward to compress the elastic means and that the guiding portion further pulls the papersheet toward the striking portion.

2. The electric stapler of claim 1, wherein the elastic guiding element is formed as a single piece by a resilient material, the pivot portion is located between the guiding portion and the elastic means, the elastic means is arranged above the guiding portion and is arc-shaped normally, when the guiding portion is pressed upward, the pivot portion pivots with respect to the striking mechanism so that the elastic means is compressed by the pivot portion to be flatter.

3. The electric stapler of claim 2, wherein the guiding portion is also arc-shaped, a curvature center of the guiding portion is located above the guiding portion and between the pivot portion and the striking portion, a curvature center of the elastic means is located above the elastic means.

4. The electric stapler of claim 3, wherein the striking mechanism has a pivot axle and an abutting face, the pivot portion of the elastic guiding element is pivotally connected to the pivot axle, an end of the elastic means remote from the pivot portion abuts against the abutting face.

5. The electric stapler of claim 4, wherein the striking mechanism further includes a front cover, the pivot axle and the abutting face are located at a face of the front cover facing the working platform.

6. The electric stapler of claim 1, wherein the switch structure includes a pivot element, a switch, and a triggering element, an end of the pivot element is pivotally connected to the striking mechanism, an other end of the pivot element has a pressing portion, the pivot element is closer to the front opening of the main body than the striking portion is, the switch is arranged in the receiving space and is connected to the striking device, the switch triggers the striking mechanism to move to the striking position to drive the striking portion to strike a nail out when the switch is triggered, the triggering element is movably arranged between the switch and the pressing portion of the pivot element, the triggering element is movable between a reset position and a triggering position, the triggering element tends to retain at the reset position, the triggering element is pushed to move toward the triggering position when the pressing portion of the pivot element is pushed by a papersheet, the triggering element triggers the switch when the triggering element is located at the triggering position.

7. The electric stapler of claim 6, wherein the pressing portion of the pivot element includes a pressing face and a pushing portion, the pressing face is V-shaped for a corner of the papersheet to abut against, the pushing portion is adapted for pushing the triggering element.

8. The electric stapler of claim 6, wherein the triggering element includes an elastic element, the triggering element is positioned on a bottom of the main body via the elastic element and tends to retain at the reset position.

9. The electric stapler of claim 8, wherein the triggering element is formed with a recess on a face thereof facing the pivot element, the recess extends along a vertical direction to allow the pivot element to move up and down.
